(19) United States
(12) Patent Application Publication
(10) Pub. No.: US 2013/0231020 A1
(43) Pub. Date: Sep. 5, 2013

(54) NOVEL AQUEOUS DISPERSION OF POLYTETRAFLUOROETHYLENE

(71) Applicants: Rong Liao, Shanghai (CN); Xuepu Mao, Shenzhen (CN); Richard George Hoeck, Hockessin, DE (US)

(72) Inventors: Rong Liao, Shanghai (CN); Xuepu Mao, Shenzhen (CN); Richard George Hoeck, Hockessin, DE (US)

(73) Assignee: E I DU PONT DE NEMOURS AND COMPANY, Wilmington, DE (US)

(21) Appl. No.: 13/883,794

(22) PCT Filed: Dec. 29, 2011
(86) PCT No.: PCT/US2011/067708

§ 371 Date: May 7, 2013

(30) Foreign Application Priority Data
Dec. 31, 2010 (CN) 201010623546.4

(51) Int. Cl. C09D 127/18; D06N 3/04; C08K 3/36; C08K 5/06; C08K 3/28

(52) U.S. Cl. CPC C09D 127/18; C08K 5/06; C08K 3/28; C08K 3/36; D06N 3/047
USPC 442/59; 524/376; 524/546

(57) ABSTRACT

Disclosed are aqueous dispersions of fluoropolymer comprising from 45 to 70 weight % of non-melt-processible polytetrafluoroethylene (PTFE) particles, and based on the weight of the PTFE particles, from 1 to 15 weight % of nonionic surfactants, and 1-10 weight % of a water soluble alkaline earth metal salt, or 0.1-10 weight % of a colloidal silica. Also disclosed are compositions comprising the aqueous PTFE dispersions of this invention and their uses for coating applications with improved critical cracking thickness.

### FIELD OF THE INVENTION

This invention relates to aqueous dispersions of non-melt-processible fluoropolymers and coatings formed from the dispersions.

### BACKGROUND OF THE INVENTION

Fluoropolymers are applied to a wide number of substrates in order to confer release, chemical and heat resistance, corrosion protection, cleanability, low flammability, and weatherability. Coatings of polytetrafluoroethylene (PTFE) homopolymers and modified PTFE provide the highest heat stability among the fluoropolymers, but unlike tetrafluoroethylene (TFE) copolymers, cannot be melt processed to form films and coatings. Therefore other processes have been developed for applying coatings of PTFE homopolymers and modified PTFE. One such process is dispersion coating which applies the fluoropolymer in dispersion form.

Dispersion coating processes typically employ such fluoropolymer dispersions in a more concentrated form than the as-polymerized dispersion. These concentrated dispersions typically contain about 6-8 weight percent of surfactant. Recently, as disclosed in U.S. Pat. No. 6,153,688 to Miura et al. and U.S. Pat. No. 6,956,078 to Cavanaugh et al., it is desirable to use aliphatic alcohol ethoxylate nonionic surfactants to avoid environmental concerns associated with aromatic group-containing nonionic surfactants, e.g., alkyl phenol ethoxylates.

Dispersion coating processes include the steps of applying concentrated dispersion to a substrate by common techniques such as spraying, roller, curtain coating or dip coating; drying the substrate to remove volatile components; and baking the substrate. When baking temperatures are high enough, the primary dispersion particles fuse and become a coherent mass. Baking at high temperatures to fuse the particles is often referred to as sintering.

In many applications such as glass cloth coating, the performance of a fluoropolymer coating is dependent on the thickness of the film applied and a thick coating is frequently desired. However, if fluoropolymer dispersions are applied too thickly in a single application, the coating will suffer crack formation and the quality of the coating will be diminished or rendered unacceptable for the desired use. Consequently, when thicker coatings are desired, a dispersion coating process essentially requires multiple passes to create a coating of the desired thickness. Critical Cracking Thickness (CCT) is a measure of the maximum thickness of a coating formed from a polymer dispersion that can be applied to a substrate in one pass without cracking during drying and subsequent baking. Because multiple passes is both energy and time consuming, the applicators constantly look for improved aqueous PTFE dispersion and/or coating composition to provide high CCT.

U.S. Pat. No. 4,391,930 to Olson discloses that aqueous PTFE dispersion comprising 5-10% nonionic surfactant, 2-8% of glass bubbles, and 0.1 to 0.5% of a water-soluble electrolyte, inter alia, barium salts. Said water-soluble electrolyte helps to improve the storage stability of the PTFE dispersion. U.S. Pat. application 2007/0207273 by English et al. discloses that aqueous PTFE dispersion comprising small amount of water soluble salt provides faster drying effect. Neither reference teaches that a water soluble salt may increase the CCT of the PTFE dispersions.

Improved aqueous fluoropolymer dispersions with high CCT are needed. The present invention provides novel aqueous fluoropolymer dispersions in nonionic surfactants comprising an effective amount of water soluble alkaline earth metal salts or colloidal silica, which have significantly higher CCT.

### SUMMARY OF THE INVENTION

This invention provides an aqueous dispersion of fluoropolymers comprising, consisting essentially of, or prepared from a mixture of:
(a) from about 45 to about 70 weight %, based on the total weight of the aqueous dispersion, of polytetrafluoroethylene particles, the polytetrafluoroethylene particles are non-melt-processible;
(b) from about 1 to about 15 weight % of a nonionic surfactant; and
(c) from about 1 to about 10 weight % of a water soluble alkaline earth metal salt, or from about 0.1 to about 10 weight % of a colloidal silica;

wherein the weight % of components (b) or (c) is based on the weight of the polytetrafluoroethylene particles.

In one embodiment, in the aqueous dispersion of the present invention, the polytetrafluoroethylene particles (a) comprise core/shell PTFE, PTFE or modified PTFE.

In one embodiment, the aqueous dispersion of the present invention comprises, consists essentially of, contains from about 50 to about 65 weight % of the polytetrafluoroethylene particles, based on the total weight of the aqueous dispersion.

In another embodiment, in the aqueous dispersion of the present invention, the polytetrafluoroethylene particles have an average particle size ranging from 200 to 300 nm.

In one embodiment, the aqueous dispersion of the present invention comprises, consists essentially of, contains preferably from about 4 to about 12 weight %, more preferably about 6 to about 10 weight % of the nonionic surfactant, based on the weight of the polytetrafluoroethylene particles.

In one embodiment, in the aqueous dispersion of the present invention, the nonionic surfactant (b) comprises, consists essentially of, contains at least one aliphatic alcohol ethoxylate, or a mixture thereof.

In one embodiment, in the aqueous dispersion of the present invention, the nonionic surfactant (b) is a mixture of more than one aliphatic alcohol ethoxylate.

In one embodiment, in the aqueous dispersion of the present invention, the nonionic surfactant (b) is a compound or a mixture of compounds of the formula:

R(OCH₂CH₂)ₙOH

wherein R is a branched alkyl, branched alkenyl, cycloalkyl, or cycloalkenyl hydrocarbon group having 8-18 carbon atoms and n is an average value of 4 to 18.

In another embodiment, in the aqueous dispersion of the present invention, the nonionic surfactant (b) is an ethoxylate of 2,6,8-trimethyl-4-nonanol having an average of about 4 to about 18 ethylene oxide (EO) units or a mixture thereof.

In a further embodiment, in the aqueous dispersion of the present invention, the nonionic surfactant (b) is a mixture of 2,6,8-trimethyl-4-nananol ethoxylates having a HLB value of from 13.1 to 14.4, and more preferably from about 13.6 to about 14.2.

In one embodiment, in the aqueous dispersion of the present invention, the water soluble alkaline earth metal salt (c) is a nitrate salt of calcium, strontium or barium, or a mixture thereof.

In one embodiment, the aqueous dispersion of the present invention comprises from 1 to 8 weight % of the water alkaline earth metal salt (c), based on the weight of the polytetrafluoroethylene particles.

In one embodiment, in the aqueous dispersion of the present invention, the colloidal silica (c) has a specific surface area from about 125 to about 420 m²/g.

In one embodiment, in the aqueous dispersion of the present invention, the colloidal silica (c) is a sodium stabilized colloidal silica and has a pH of 8.4-9.9 at 25° C.

In one embodiment, the aqueous dispersion of the present invention comprises from 1 to 8 weight % of the colloidal silica (c), based on the weight of the polytetrafluoroethylene particles.

In one embodiment, the aqueous dispersion of the present invention is essentially free of glass bubbles.

The invention also provides a coating composition comprising, consisting essentially of, or prepared from the aqueous dispersions described above.

The invention further provides a substrate coated with the aqueous dispersions or the coating compositions described above. In one embodiment, the substrate coated with the aqueous dispersions or coating compositions of the present invention is porous fabric.

In one embodiment, in the substrate coated with the aqueous dispersions or coating compositions of the present invention, the nonionic surfactant (b) has been thermally removed.

The aqueous dispersions of the present invention possess both a significant level of CCT, and high dispersion stability. The coated substrates of the present invention are free from problems such as coloration. Furthermore, the processor benefits from the high CCT and improved coatability, which lead to improved productivity and yields.

Various other features, aspects, and advantages of the present invention will become more apparent with reference to the following description, examples, and appended claims.

### DETAILS OF THE INVENTION

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight.

As used herein, the term “produced from” is synonymous to “comprising”. As used herein, the terms “comprises,” “comprising,” “includes,” “including,” “has,” “having,” “contains” or “containing,” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus.

The transitional phrase “consisting of” excludes any element, step, or ingredient not specified. If in the claim, such a phrase would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally discussed, provided that theses additional materials, steps features, components, or elements do not materially affect the basic and novel characteristic(s) of the claimed invention. The term “consisting essentially of” occupies a middle ground between “comprising” and “consisting of”.

The transitional phrase “essentially no” components or “essentially free” of components, it is meant that the compositions of the invention should contain less than 1% by weight, preferably zero percent by weight, of the components, based on the total weight of the compositions.

The term “comprising” is intended to include embodiments encompassed by the terms “consisting essentially of” and “consisting of”. Similarly, the term “consisting essentially of” is intended to include embodiments encompassed by the term “consisting of”.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. For example, when a range of “1 to 5” is recited, the recited range should be construed as including ranges “1 to 4”, “1 to 3”, “1-2”, “1-2 & 4-5”, “1-3 & 5”, and the like. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

Further, unless expressly stated to the contrary, “or” refers to an inclusive “or” and not to an exclusive “or”. For example, a condition A “or” B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

In describing and/or claiming this invention, the term “homopolymer” refers to a polymer derived from polymerization of one species of monomer; “copolymer” refers to a polymer derived from polymerization of two or more species of monomers. Such copolymers include dipolymers, terpolymers or higher order copolymers.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

In the above recitations, the term “branched alkyl” having 8-18 carbon atoms includes, for example, 2,2-dimethyl hexyl, 2,6,8-trimethyl-4-nonanyl, or the different isomers of octanyl, nonanyl, decanyl are included, as long as the total carbon number is between 8 to 18. “Branched alkenyl” is defined similarly. Examples of cycloalkyl” having 8-18 carbon atoms include 4-butylcyclopentyl and 2,4,6-trimethylcyclohexyl, or the like. “Cycloalkenyl” is defined similarly.

Embodiments of the present invention as described in the Summary of the Invention include any other embodiments described herein, can be combined in any manner, and the descriptions of variables in the embodiments pertain not only to the aqueous dispersions of the present invention but also to the coating compositions and the substrate coated with the aqueous dispersions or coating compositions of the present invention.

The materials, methods, and examples herein are illustrative only and, except as specifically stated, are not intended to be limiting. Although methods and materials similar or equivalent to those described herein can be used in the practice or testing of the present invention, suitable methods and materials are described herein.

The invention is described in detail hereinunder.

Polytetrafluoroethylene Dispersions

The aqueous dispersion of fluoropolymers of the present invention is made by dispersion polymerization (also known as emulsion polymerization). Fluoropolymer dispersions are comprised of particles of polymers made from monomers wherein at least one of the monomers contains fluorine.

The fluoropolymer particles used in the aqueous dispersion employed in this invention are non-melt-processible particles of polytetrafluoroethylene (PTFE) including modified PTFE when isolated and dried are not melt-processible.

By non-melt-processible, it means that no melt flow is detected when tested by the standard melt viscosity determining procedure for melt-processible polymers.

PTFE refers to the polymerized tetrafluoroethylene by itself without any significant comonomer present. Modified PTFE refers to copolymers of TFE with such small concentrations of comonomer that the melting point of the resultant polymer is not substantially reduced below that of PTFE. The concentration of such comonomer is preferably less than 1 wt %, more preferably less than 0.5 wt %. The modified PTFE contains a small amount of comonomer modifier which improves film forming capability during baking (fusing), such as perfluoroolefin, notably hexafluoropropylene (HFP) or perfluoro(alkyl vinyl)ether (PAVE), where the alkyl group contains 1 to 5 carbon atoms, with perfluoro(ethyl vinyl) ether (PEVE) and perfluoro(propyl vinyl)ether (PPVE) being preferred. Chlorotrifluoroethylene (CTFE), perfluorobutyl ethylene (PFBE), or other monomer that introduces bulky side groups into the molecule are also included.

It has been recognized in U.S. Pat. No. 6,841,594 and U.S. Pat. No. 7,619,039 to Jones et. al. and U.S. Pat. No. 6,956,078 to Cavanaugh et al. that certain non-melt processible fluoropolymers of a core/shell configuration having a core of high molecular weight PTFE and a shell of lower molecular weight PTFE or modified PTFE possess excellent shear stability and high CCT.

Particularly preferred non-melt-processible polytetrafluoroethylene include the core/shell fluoropolymers described above. Said core/shell fluoropolymer comprises a core of high molecular weight PTFE and a shell of lower molecular weight PTFE.

In one preferred embodiment, in the aqueous dispersion of the present invention, the non-melt-processible PTFE particles comprise core/shell PTFE, PTFE, modified PTFE or a mixture thereof.

The standard specific gravity (SSG) is generally inversely proportional to the molecular weight of PTFE (including core/shell PTFE and modified PTFE). The non-melt-processible PTFE typically have a SSG of about 2.14 to about 2.40. Preferably, the SSG ranges from about 2.17 to about 2.30, more preferably from about 2.20 to about 2.25, and most preferably from about 2.22 to about 2.23.

The non-melt-processible PTFE particles in the aqueous dispersion used in this invention preferably have a number average particle size of about 100 nm to about 400 nm, most preferably, about 200 nm to about 300 nm.

Process for Producing the Polytetrafluoroethylene Dispersion

A typical process for the aqueous dispersion polymerization of preferred PTFE polymer is a process wherein TFE vapor is fed to a heated reactor containing fluorosurfactants, paraffin wax and deionized water. A chain transfer agent may also be added if it is desired to reduce the molecular weight of the PTFE. A free-radical initiator solution is added and, as the polymerization proceeds, additional TFE is added to maintain the pressure. The exothermic heat of reaction is removed by circulating cooling water through the reactor jacket. After several hours, the feeds are stopped, the reactor is vented and purged with nitrogen, and the raw dispersion in the vessel is transferred to a cooling vessel. Paraffin wax is removed and the dispersion is isolated and stabilized with nonionic surfactant.

The aqueous fluoropolymer dispersion of the invention can be referred to as a stabilized aqueous fluoropolymer dispersion which means that it contains sufficient nonionic surfactant to prevent coagulation of the PTFE particles when only trace amounts of fluorosurfactant are present in the dispersion.

Fluorosurfactants are typically used in the dispersion polymerization of fluoropolymers, the fluorosurfactants functioning as a non-telogenic dispersing agent as described in U.S. Pat. No. 2,559,752 to Berry. These fluorosurfactants are used as a polymerization aid for dispersing and, because they do not chain transfer, they do not cause formation of polymer with undesirable short chain length. Preferably, the fluorosurfactant is a perfluorinated carboxylic or sulfonic acid having 6-10 carbon atoms and is typically used in salt form. Suitable fluorosurfactants are ammonium perfluorocarboxylates, e.g., ammonium perfluorooctanoate (APFO). The fluorosurfactants are usually present in the amount of 0.02 to 1 wt % with respect to the amount of polymer formed.

Significant work has been conducted to find suitable replacements for APFO. Much of the work has centered around the use of fluoroether emulsifying agents. These replacements are effective in the dispersion polymerization of fluoropolymers, such replacements include but are not limited to U.S. Pat. No. 3,271,341 to Garrison, U.S. Pat. No. 6,878,772 to Visca et al., U.S. Pat. application 2007/0015864 to Hintzer et al., U.S. Pat. application 2008/0114122 to Brothers and Gangal, U.S. Pat. application 2008/0207859 to Matsuoka et al., U.S. Pat. No. 7,589,234 to Morita et al., and PCT Pat. application WO2010/003929 to Marchionni et al.

The initiators preferably used to make fluoropolymer dispersion for use in the process of this invention are free radical initiators. They may be those having a relatively long half-life, preferably persulfates, e.g., ammonium persulfate or potassium persulfate. To shorten the half-life of persulfate initiators, reducing agents such as ammonium bisulfite or sodium metabisulfite, with or without metal catalysis salts such as Fe (III), can be used. Alternatively, short half-life initiators such as potassium permanganate/oxalic acid can be used. In addition to the long half-life persulfate initiators, small amounts of short chain dicarboxylic acids such as succinic acid or initiators that produce succinic acid such as disuccinic acid peroxide (DSP) may be also be added in order to reduce coagulum.

As disclosed in U.S. Pat. No. 7,612,139, the processes for producing a core/shell PTFE relates to the amount of initiator present during the first (core) stage part of polymerization and during the later (shell) stage of polymerization as well as the presence or absence of telogenic agent and comonomer being introduced.

Unless removed, fluorosurfactant remains in fluoropolymer dispersions. Because of environmental concerns, processes have been developed to reduce the fluorosurfactant content in aqueous fluoropolymer dispersions to decrease emissions of fluorosurfactants and/or decrease or eliminate the need to capture fluorosurfactants during end use processing of fluoropolymer dispersions. Significant efforts have been made to reduce the amount of fluoroosurfactnats in the aqueous dispersion and/or recover it using an anion exchange process to treat stabilized dispersion. Disclosure can be found in U.S. Pat. No. 3,536,643 to Strykler, U.S. Pat. No. 3,882,153 to Seki et al., U.S. Pat. No. 4,282,162 to Kuhls, U.S. Pat. No. 6,833,403 to Bladel et al., U.S. Pat. No. 7,659,329 to Swearingen, U.S. Pat. No. 7,666,927 to Combes et al., and U.S. Pat. No. 7,671,111 to Noelke et al.

To produce dispersion with low fluorosurfactant content as described below, sufficient nonionic surfactant as is described in more detail hereinafter is added to prevent coagulation of the fluoropolymer dispersion when the fluorosurfactant content is reduced. The PTFE solids content in the aqueous dispersion ranges from about 10 to about 70 weight %. Typically, nonionic surfactant is added for stabilization prior to fluorosurfactant reduction and then as desired, concentration of the dispersion is conducted. For concentrating, the fluoropolymer dispersion is held at a temperature above the cloud point of the nonionic surfactant. Once concentrated to about 45 to about 70 weight % of the fluoropolymer, and preferably about 50 to about 65 weight % of the fluoropolymer, the upper clear supernate is removed. Further adjustment of the final solids concentration and surfactant are made as needed. One patent illustrative of a process for concentrating is U.S. Pat. No. 3,037,953 to Marks and Whipple.

Examples of commercially available PTFE dispersions include Teflon®PTFE TE-3875; and Teflon® PTFE TE-3865C supplied by DuPont, and Fluon® PTFE AD911, AD912, or AD938 supplied by AGC Chemicals.

In a preferred embodiment of the invention, the fluoropolymer is fibrillating. Fine powder resin isolated from dispersion and dried can be formed into useful articles by a lubricated extrusion process known as paste extrusion. The fluoropolymer resin is blended with a lubricant and then shaped by an extrusion process. The beading obtained is coherent and microscopic examination reveals that many particles are linked by fibrils of PTFE which have been formed despite the procedure being conducted well below the melt temperature. Thus by “fibrillating”, it is meant that a lubricated resin forms a continuous extrudate when extruded through a 1600:1 reduction die at about 18.4 weight percent isoparaffin lubricant sold under the trademark Isopar™ K by ExxonMobil Chemical. A further strengthening of the beading beyond the “green strength” obtained by fibrillation is accomplished by sintering after the lubricant has been volatized.

Nonionic Surfactants

Any of a wide variety of nonionic surfactants such as alkyl phenol ethoxylates and aliphatic alcohol ethoxylates can be used in the aqueous dispersions of the invention. However, surfactants containing aromatic groups, e.g., alkyl phenol ethoxylates, can thermally decompose to form harmful compounds that may have adverse environmental impact. These surfactants thermally degrade and cause discoloration to the product, or produce tar-like substances that buildup on wall of the processing equipment and can be transferred to the product causing contamination.

Suitable nonionic surfactants used in this invention are those can be burned off cleanly without thermally decomposing on a substrate and leaving lower residuals. More preferably, the nonionic surfactants used in the aqueous dispersion of the invention are aliphatic alcohol ethoxylates or mixtures thereof, which preferably provide a desired cloud point during concentration and which provide desired properties in the dispersion, e.g., low burn off temperature, dispersion stability, etc.

The cloud point of a surfactant is a measure of the solubility of the surfactant in water. The surfactants in the aqueous dispersion employed in accordance with the invention preferably have a cloud point of about 30° C. to about 90° C., preferably about 35° C. to about 85° C.

Nonionic surfactants of the type generally used to stabilize fluoropolymer dispersions can be either liquids or solids at room temperature. Generally low viscosity liquids are preferred from a handling point of view. High viscosity liquids are more difficult to handle and often require heated tanks and lines to keep the viscosity low enough for ease in handling. Some of the apparent liquid surfactants are physically meta-stable in that they may exist as liquids for several days and then turn into pasty solids. A liquid surfactant is considered to be a stable liquid if it remains liquid for 3 days at room temperature after being chilled to 5° C. and then warmed to room temperature (about 23±3° C.). Sometimes water is added to the surfactant to lower its viscosity and making it easier to handle. However, too much water detracts from the desire to produce more concentrated dispersions.

In one embodiment, in the aqueous dispersion of this invention, the nonionic surfactants contains 0-25 weight % water, preferably 0-15 weight % water and is a stable liquid at room temperature.

Especially preferred aliphatic alcohol ethoxylates are a compound or a mixture of compounds of the formula:

R(OCH₂CH₂)ₙOH

wherein R is a branched alkyl, branched alkenyl, cycloalkyl, or cycloalkenyl hydrocarbon group having 8-18 carbon atoms and n is an average value of 4 to 18.

For example, a preferred ethoxylate used in this invention can be considered to be prepared from (1) a primary alcohol that is comprised of a hydrocarbon group selected from branched alkyl, branched alkenyl, cycloalkyl or cycloalkenyl, or (2) a secondary or tertiary alcohol. In any event, the ethoxylate used in accordance with this invention does not contain an aromatic group. The number of ethylene oxide units in the hydrophilic portion of the molecule may comprise either a broad or narrow monomodal distribution as typically supplied or a broader or bimodal distribution which may be obtained by blending.

Nonionic surfactants employed in dispersions employed in accordance with the invention are preferably ethoxylates of saturated or unsaturated secondary alcohols having 8-18 carbon atoms. Secondary alcohol ethoxylates possess advantages over both primary alcohol ethoxylates and phenol ethoxylates including lower aqueous viscosities, more narrow gel ranges, and less foaming. Moreover, ethoxylates of secondary alcohols provide improved surface tension lowering and thus excellent wetting in end use applications such as coating operations.

In addition to the above advantages, the preferred alkyl alcohol ethoxylates burn off at a lower temperature (about 50° C. lower) than the conventional alkyl phenol ethoxylates. This can be beneficial in some applications where the surfactant must be removed thermally but the product cannot be sintered. Examples of applications of these types are impregnated fibers for sealing and filtration applications. With the conventional alkyl phenol ethoxylates, the surfactant burn-off temperature is very near the sintering temperature. The alcohol ethoxylate surfactants thus offer a wider operating window.

In a preferred form of the aqueous dispersion employed in accordance with the invention, the nonionic surfactant is an ethoxylate of 2,6,8-trimethyl-4-nonanol having an average of about 4 to about 18 ethylene oxide (EO) units, most preferably, ethoxylates of 2,6,8-trimethyl-4-nananol having an average about 6 to about 12 ethylene oxide units, or mixture thereof.

Suitable nonionic surfactants typically have a hydrophile-lipophile-balance (HLB) value of from about 10.0 to about 20.0, preferably from about 10.5 to about 18.0, more preferably from about 12.0 to about 15.0. Generally, the lower the number of carbon atoms in the R group and the larger the n integer, the higher the HLB value.

Examples of preferred surfactants of this type are those sold under the trade name Tergitol™, for example, TMN-6 (nominally 6 EO units, HLB value is 13.1) and TMN-10 (nominally 10 EO units, HLB value is 14.4), these are available from Dow Chemical Corporation. A blend of Tergitol™ TMN-6 and Tergitol™ TMN-10 is also available from Dow Chemical Corporation as Tergitol™ TMN-100× (HLB value is 14.1).

Preferred blends of Tergitol™ TMN-6 and Tergitol™ TMN-10 may have a blending ratio vary anywhere in the range from 30:70 to 50:50.

In one embodiment, the nonionic surfactant of the dispersion employed in the invention is a mixture of 2,6,8-trimethyl-4-nonanol ethoxylates having a HLB value of from about 13.1 to about 14.4, and more preferably from about 13.6 to about 14.2.

The nonionic surfactants are generally present in the dispersion of this invention in amounts of about 1 to about 15 weight %, preferably about 4 to about 12 weight %, more preferably about 6 to about 10 weight %, based on the weight of the non-melt-processible PTFE particles.

The nonionic surfactant as described herein are typically added to the aqueous PTFE dispersions of this invention prior to the concentration and the fluorosurfactant reduction steps of the raw PTFE dispersion as will be described below.

Dispersion Concentration Procedure

The aqueous dispersion in accordance with the invention is preferably produced by concentrating the as-polymerized dispersion. Preferably, the dispersion concentration operation, the dispersion is concentrated with the aid of the aliphatic alcohol ethoxylate nonionic surfactant using the procedure taught in Marks et al., U.S. Pat. No. 3,037,953, and in Holmes, U.S. Pat. No. 3,704,272 to raise the solids content. For example, the solids contents can be increased from about 35 wt % to about 60 wt % using a process of this type. Miura et al., U.S. Pat. No. 6,153,688 discloses a similar process.

Water Soluble Alkaline Earth Metal Salts

Suitable water soluble alkaline earth metal salts for the aqueous fluoropolymer dispersion of this invention are characterized to have good water solubility, can effectively increase the CCT, can be added at any time during manufacture or processing prior to drying, is compatible with salts normally used or formed during polymerization, fluorosurfactant reduction and/or concentration of the dispersion. Preferably, the water soluble alkaline earth metal salt or mixture thereof are colorless, or alt least will not alter the substrate coated with the aqueous dispersion and/or coating compositions of this invention.

Examples of effective water soluble alkaline earth metal salts for the practice of the invention include magnesium, calcium, strontium, or barium salts of bromide, chloride, or nitrate.

Preferably water soluble alkaline earth metal salts include nitrate salt of calcium, strontium, barium, or mixture thereof; more preferably, barium nitrate.

In one embodiment, in the aqueous dispersion of the present invention, the water soluble alkaline earth metal salt is magnesium, calcium, strontium, or barium salts of bromide, chloride, or nitrate, or mixture thereof. In another embodiment, in the aqueous dispersion of the present invention, the water soluble alkaline earth metal salt is nitrate salt of calcium, strontium or barium, or mixture thereof. In a further embodiment, in the aqueous dispersion of the present invention, the water soluble alkaline earth metal salt is barium nitrate.

A useful amount of the water soluble alkaline earth metal salts is about 1 to about 10 weight %, preferably about 1 to about 8 weight %, more preferably about 2 to about 6 weight %, wherein the weight % is based on the weight of the PTFE particles. When the amount of the water soluble alkaline earth metal salts is above 1 weight %, appreciable increasing of the dispersion's CCT can be observed. When the amount of the water soluble alkaline earth metal salts exceeds 10 weight %, the dispersion becomes too thick which may cause processing difficulty, not to mention that the chemical resistance and nonstick (release) properties of the coating are adversely affected.

Colloidal Silica

Colloidal silica used in the aqueous dispersion of this invention is generally in the form of an aqueous suspension containing fine sized amorphous, nonporous, and typically spherical silica particles.

Colloidal silica is most often prepared in a multi-step process where an alkali-silicate solution is partially neutralized, leading to the formation of silica nuclei. The resulting suspension is then concentrated and stabilized.

Colloidal silica normally has a configuration in which negatively-charged silica particles having a siloxane structure are dispersed in water. The amount of negative charge increases as the pH increases. The negatively-charged silica particles are surrounded by sodium ions and/or ammonium ions contained in the aqueous solution so that an electrical double layer is formed. Aggregation of colloidal silica can be suppressed by adjusting the pH of the aqueous suspension to 8 to 11 (weakly alkaline region). If the pH of the aqueous suspension is lower than 8, the colloidal silica may aggregate. If the pH of the aqueous suspension is higher than 11, the colloidal silica may be partially dissolved during long-term storage, so that the desired CCT increasing properties may not be obtained.

Preferably, colloidal silica suspension is stabilized with sodium ions, has a silica content (calculated at SiO₂) of about 30 to about 50 weight %, and a pH of 8.4-9.9 at 25° C.

In one embodiment, in the aqueous dispersion of the present invention, the colloidal silica is in an aqueous suspension stabilized with sodium ions, has a silica content (calculated at SiO₂) of about 30 to about 50 weight %, and a pH of 8.4-9.9 at 25° C.

Suitably, the colloidal silica particles have a specific surface area from about 50 to about 900 m²/g, preferably from about 70 to about 600 m²/g, more preferably from about 100 to about 500 m²/g, and most preferably from about 125 to about 420 m²/g.

In one embodiment, in the aqueous dispersion of the present invention, the colloidal silica has a specific surface area of 100-500 m²/g. In another embodiment, in the aqueous dispersion of the present invention, the colloidal silica has a specific surface area of 125-420 m²/g.

Due to the high specific surface area, the colloidal silica can effectively increase the inventive PTFE aqueous dispersion's CCT. Additionally, because of the low refractive index of colloidal silica, the PTFE aqueous dispersion when applied to substrates also provides favorable properties of the coating such as transparent and high gloss. Noted that, in the aqueous dispersion of the present invention, mixtures of colloidal silica suspensions can also be used.

Examples of colloidal silica suitable for the practice of the invention include Ludox™ AM, Ludox™ HS, Ludox™ TM, and Ludox™ SM, available from W.R. Grace & Co., Conn, USA; Nalco 1050, Nalco 2327 available from Nalco Chemical Co., Naperville, Ill., USA.

Ludox™ AM-30 is particularly preferred and exemplified herein. This colloidal silica suspension has a pH of ˜9 at 25° C., density of 1.21 g/mL at 25° C. The silica particles are surface-modified with aluminum having a specific surface area of ˜220 m²/g, and an average particle size of 12 nm in diameter.

A useful amount of the colloidal silica is about 0.1 to about 10 weight %, preferably about 1 to about 8 weight %, more preferably about 3 to about 6 weight %, wherein the weight % is based on the weight of the PTFE particles. When the amount of the colloidal silica is above 0.1 weight %, increasing of the dispersion's

CCT can be observed. When the amount of the colloidal silica exceeds 10 weight %, the dispersion becomes too thick which may cause processing difficulty, not to mention that the chemical resistance and nonstick (release) properties of the coating are adversely affected.

Fillers, Pigments and Additives

The fluoropolymer aqueous dispersion and/or coating composition employed in accordance with the invention optionally contains fillers, pigments and other additives known for use in aqueous dispersion and/or coating compositions provided that such materials are not detract from the basic and novel characteristics of the fluoropolymer aqueous dispersion and/or coating composition, do not significantly adversely affect the performance, and are employed in sufficiently quantities. For example, mineral fillers such as talc and clays.

Coating Compositions

The invention also provides a coating composition comprising (a) dispersed non-melt-processible polytetrafluoroethylene particles with (b) an aliphatic alcohol ethoxylate nonionic surfactant, and (c) a water soluble alkaline earth metal salt or a colloidal silica in an aqueous liquid medium. The coating composition of this invention is effective to increase the critical cracking thickness of a coated substrate by at least about 10% compared to otherwise identical coating composition without the component (c) water soluble alkaline earth metal salt or colloidal silica.

Coating Applications

The aqueous dispersions of this invention can be used as coating compositions on any number of substrates including metal and glass. The aqueous dispersions are applied to substrates and baked to form a baked layer on the substrate. When baking temperatures are high enough, the primary dispersion particles fuse and become a coherent mass. Coating compositions comprising the aqueous dispersions of this invention can be used to coat fibers of glass, ceramic, polymer or metal and fibrous structures such as conveyor belts or architectural fabrics, e.g., tent material. The coatings of this invention when used to coat metal substrates have great utility in coating cooking utensils such as frying pans and other cookware as well as bakeware and small electrical household appliances such as grills and irons. Coatings of this invention can also be applied to equipment used in the chemical processing industry such as mixers, tanks and conveyors as well as rolls for printing and copying equipment.

Alternately the aqueous dispersions can be used to impregnate fibers for sealing and filtration applications. Further the aqueous dispersions of this invention can be deposited onto a support and subsequently dried, thermally coalesced, and stripped from the support to produce self-supporting films cast from the aqueous dispersion. Such cast films are suitable in lamination processes for covering substrates of metal, plastic, glass, concrete, fabric and wood.

Aqueous dispersions in accordance with the invention do not require anionic non-fluorinated surfactants for stability control after fluorosurfactant removal or during concentration. This enables more formulation flexibility in metal coating applications and, in color glass cloth coating applications, the undesirable color which can be imparted by such surfactants.

Substrates

The substrate used in this invention can be any of a variety of structures including a sheet, film, cloth, container, fabricated part, fiber or fibrous article. As will be described in more detail below, the substrate used in a preferred embodiment of this invention include polymer, glass, ceramic and composites thereof. In one preferred embodiment the substrate is glass cloth. In another preferred embodiment the substrate is aramid fiber, glass fiber, or natural fiber, preferably in the form of braids of such fiber. Braided fibers with fluoropolymer coatings are useful for making gaskets. Typically, the fluoropolymer in such gasket materials are unsintered. In another embodiment, the substrate is bakeware.

Process of Producing a Coated Substrate

In the process of the invention, a fluoropolymer coated substrate is made by applying the aqueous fluoropolymer dispersion and/or coating composition with reduced fluorosurfactant content as discussed above to a substrate to form a wet coating on the substrate. The aqueous fluoropolymer dispersion and/or coating composition can be applied to a substrate by conventional means. Both single and multiple layer coating applications can be used. In multiple layer processes, the various layers can be the same or different.

The application method used is dependent upon the type of fluoropolymer coating composition as well as the substrate to be coated. Spray and roller applications forming each layer are convenient application methods. Other well-known coating methods including dipping, curtain coating and blade coating are suitable.

Fluoropolymer Coated Strands for Gaskets and Packing

Fluoropolymer gasket and packing materials can be made in accordance with the invention by submerging a fibrous substrate, preferably braided and up to 4 inches in diameter, into the aqueous fluoropolymer dispersion and/or coating composition of this invention. Preferred fibrous substrates include those containing glass fiber, aramid fiber such as that sold under the trademark Kevlar® by the DuPont Company, PTFE fiber, natural fibers such as cotton, and mixtures of such fibers. The aqueous fluoropolymer dispersion and/or coating composition preferably contains about 50 to about 65 weight % solids depending on the desired coating thickness and degree of impregnation with the fluoropolymer. Non-melt-processible PTFE is the preferred fluoropolymer for this application.

In performing the process, the fibrous substrate may be submerged as a complete roll for about 1 to about 24 hours or passed as a single strand through a PTFE dispersion bath. Following the coating step, the PTFE coated substrate is placed in or passes through a oven to remove the water and surfactant. Adding water soluble alkaline earth metal salts or colloidal silica particles to the dispersion increases the CCT of the coated substrate.

The fluoropolymer coated fibrous substrates are useful in many applications including gaskets and is especially useful packing to extend the life of various pumps, valves, and agitators compared to packing which does not contain fluoropolymer. The fluoropolymer, especially a PTFE coated surface, provides a low coefficient of friction to reduce wear and heat generated from repeated rubbing under high-pressure loads. In addition, the PTFE impregnated substrate has excellent thermal resistance (−100° C.−260° C.), chemical inertness, and acid-base resistance (pH 0-14).

Glass Cloth Coating

Fluoropolymer coated glass cloth can be made by coating the glass cloth substrate with the aqueous fluoropolymer dispersions and/or coating compositions of this invention, typically PTFE dispersion, which is dried, baked and sintered in an oven. Usually, a multiple pass process is used to provide the desired coating thickness although sintering may be omitted in the early passes.

The coating is typically performed using dip-tank with the dispersion concentration being about 50 to about 65% solids. In a typical coating process, the glass cloth with wet coating then enters an oven in which water is removed in a drying zone, surfactant is removed in a baking zone, and then sintering is performed in a sintering zone to fuse the fluoropolymer particles

Fluoropolymer coated glass cloth has excellent nonstick, weather resistance, chemical resistance and wide temperature application range and thus has a wide variety of industrial uses. Principal uses include architecture, e.g., tent-like roof structures, and manufacturing process equipment, e.g., conveyor belts for food processing.

The fluoropolymer aqueous dispersion in accordance with the invention preferably retain a high Critical Cracking Thickness (CCT) after fluorosurfactant removal and can avoid the need to add, e.g., acrylic binders, or anionic surfactant. Again, avoiding the presence of these additives in the dispersion enables more formulation flexibility in metal coating applications and undesirable color glass cloth coating applications.

### EXAMPLES

The abbreviation “E” stands for “Example” and “C” stands for “Comparative Example” is followed by a number indicating in which example the aqueous dispersion is prepared. The examples and comparative examples were all prepared and tested in a similar manner. Percentages are by weight unless otherwise indicated.

Materials

(a1) PTFE: raw dispersion containing ˜41-43 weight % of core/shell PTFE has a average particle size of 270 nm, dispersion was blended with component (b) and concentrated according the procedure described below to the final dispersion having solid content ˜50-60 weight %.

(a2) PTFE: raw dispersion containing ˜41-43 weight % of PTFE has a average particle size of 220 nm, dispersion was blended with component (b) and concentrated according the procedure described below to the final dispersion having solid content ˜55-60 weight %.

(b1) Tergitol™ TMN-10: a nonionic surfactant, has nominally 10 EO units/mole, and a cloud point of 76° C., purchased from Dow Chemical.

(b2) Tergitol™ TMN-6: a nonionic surfactant, has nominally 6 EO units/mole, and a cloud point of 36° C., purchased from Dow Chemical.

(c1) Barium nitrate (CAS number 10022-31-8): a water soluble alkaline earth metal salt, purchased from SCRC ( [symbol] ).

(c2) Colloidal silica (CAS number 7631-86-9): a 30 weight % solids suspension in water, purchased from W. R. Grace & Co. (Conn. USA) under Ludox™ AM-30.

Procedure to Prepare the PTFE Aqueous Dispersion

TFE was polymerized using ammonium persulfate as the initiator to produce a raw PTFE homopolymer dispersion containing PTFE particles having an SSG of a about 2.20 and a number average particle size of approximately of 195 nm to 245 nm; while for the core/shell type, the average particle size was from 245 nm to 305 nm. The raw dispersion contained approximately 45% fluoropolymer solids and has an APFO content of about 1800 ppm.

Raw dispersion was stabilized by adding nonionic surfactant Tergitol™ TMN-10 and/or Tergitol™ TMN-6 to provide approximately 4 wt % nonionic surfactant based on the weight of the PTFE particles.

Fluorosurfactants reduction was performed using commonly known ion exchange technology. The APFO level of dispersion is reduced to less than 50 ppm. Ammonium hydroxide was added adjust the pH to between about 9.5 and about 11.0. The dispersion was then thermally concentrated, and Tergitol™ TMN-10 and/or Tergitol™ TMN-6 was added to obtain a PTFE solid content of between 50 and 61% by weight based on the weight of the dispersion. The aqueous dispersion after the ion exchange treatment is a stabilized dispersion, component (c) can be added directly omitting the concentration step to provide fluoropolymer aqueous dispersion having high CCT.

When a blend of Tergitol™ TMN-10 and Tergitol™ TMN-6 is used, the blend composition is represented by the HLB value of the blend, which is calculated by the formula: HBL of the blended surfactants ═(HLB of TMN-10×wt % of TMN-10)+(HLB of TMN-6×wt % of TMN-6). Followed by addition of either water soluble alkaline earth metal salt or colloidal silica, nonionic surfactant(s) was added to the dispersion to bring the final surfactant(s) concentration to 6, 8 or 10%, respectively, by weight based on the PTFE particles.

Test Methods

### Raw Dispersion Properties:

Solids content of PTFE raw (as polymerized) dispersion are determined gravimetrically by evaporating a weighed aliquot of dispersion to dryness, and weighing the dried solids. Solids content is stated in weight % based on combined weights of PTFE and water. Alternately solids content can be determined by using a hydrometer to determine the specific gravity of the dispersion and then by reference to a manufacturer provided table relating specific gravity to solids content.

Raw dispersion particle size (RDPS) is measured by photon correlation spectroscopy.

### Fluoropolymer Resin Properties:

Standard specific gravity (SSG) of PTFE resin is measured by the method of ASTM D-4895. If a surfactant is present, it can be removed by the extraction procedure in ASTM-D-4441 prior to determining SSG.

### Nonionic Surfactant Content:

Amounts of surfactants and solids content of stabilized dispersion are determined gravimetrically by evaporating a small weighed aliquot of the PTFE dispersion to dryness following in general ASTM D-4441 but using a time and temperature such that water but not the surfactant is evaporated. This sample is then heated at 380° C. to remove the surfactant and reweighed. Surfactant content is stated in wt % based on the weight of the PTFE particles.

### Fluorosurfactant Content:

Ammonium perfluorooctanoate (APFO) is measured using a Hewlett Packard 5890 gas chromatograph. The fluorosurfactant is esterified using a straight chain alcohol of no greater than 3 carbons and introduced into the GC. Fluorosurfactant content is reported based on total weight percent of fluorosurfactant in the dispersion.

### Critical Cracking Test Procedure (CCT):

The CCT test procedure used in the examples is a procedure to test the maximum film thickness that was obtained by coating a PTFE aqueous dispersion on an alumina plate (10 cm×30 cm, 3 mm thick) having average surface roughness (Ra) below 5 μm. Dispersions were pre-filtered through a nylon membrane of 50 μm pore size, then 5 mL of the PTFE aqueous dispersion was applied to the clean flat alumina plate by using BYK Gardner Film Applicator ( [symbol] [symbol] ) with No. 8 rod (8 [symbol] ) with a spreading speed of 5 cm/sec.

Each dispersion was applied to three plates. The three coated plates were dried at room temperature with a pre-defined tilt angle to obtain a coated plate having varied coating thickness until the coated layer turned white, then oven dried at 105° C. for 10 min, followed by baked at 430° C. for 1 min. The plates were removed from the oven and allowed to stand until they reach room temperature. After cooling, cracks were observed in thick portions of the coating and faded away as the thickness decreased. The critical cracking thickness of a testing sample was determined by measuring the thickness of the coating at ten points with a thickness meter( [symbol] ) and average the data.

Embodiments of the present invention are further defined in the following Examples. Compositions of the examples and comparative examples as well as the evaluation results are shown in Tables 1 to 4.

TABLE 1
Comparative Examples

| Material | C1 | C2 | C3 | C4 | C5 | C6 | C7 | C8 | C9 |
|---|---|---|---|---|---|---|---|---|---|
| (a1) PTFE, % | 60.0 | 56.3 | 60.7 | 60.0 | 59.2 | 59.2 | 60.4 | 58.4 | 58.4 |
| (b) Nonionic | 6.0 | 6.0 | 6.0 | 6.0 | 8.0 | 8.0 | 10.0 | 10.0 | 10.0 |
| surfactant(s), %* | | | | | | | | | |
| HLB value | 14.4 | 14.0 | 13.9 | 13.8 | 13.9 | 13.8 | 14.0 | 13.9 | 13.8 |
| Critical Cracking | 8-10 | 10-12 | 10-12 | 9-11 | 10-12 | 10-12 | 14-15 | 10-12 | 12-14 |
| Thickness, μm | | | | | | | | | |

*The % of component (b) is based on the PTFE particles weight.

From the results of Table 1, the following are evident.

From the comparison between the comparative examples 1 to 9, the dispersion containing 6 weight % of aliphatic alcohol ethoxylate has a CCT of 8-12 micrometers. At 8 weight %, the CCT of the dispersion improves to 10-12 micrometers; at 10 weight %, the CCT of the dispersion improves to 10-15 micrometers. Thus, as the amount of nonionic surfactant increases, so does the CCT of the dispersion, which is known.

TABLE 2

| Material | C2 | C4 | E1 | E2 | E3 | C7 | C9 | E4 | E5 | E6 |
|---|---|---|---|---|---|---|---|---|---|---|
| (a2) PTFE, % | 56.3 | 60.0 | 58.2 | 59.6 | 58.3 | 60.4 | 58.4 | 56.3 | 58.1 | 56.8 |
| (b) Nonionic | 6.0 | 6.0 | 6.0 | 6.0 | 6.0 | 10.0 | 10.0 | 10.0 | 10.0 | 10.0 |
| surfactant(s), %* | | | | | | | | | | |
| HLB value | 14.0 | 13.8 | 14.0 | 13.8 | 13.8 | 14.0 | 13.8 | 14.0 | 13.8 | 13.8 |
| (c1) Barium | — | — | 3.0 | 1.0 | 5.0 | — | — | 3.0 | 1.0 | 5.0 |
| nitrate, %* | | | | | | | | | | |
| Critical Cracking | 10-12 | 9-11 | 12-14 | 12-14 | 15-17 | 14-15 | 12-14 | 16-18 | 15-17 | 23-27 |
| Thickness, μm | | | | | | | | | | |

*The % of components (b) and (c) are based on the PTFE particles weight.

From the results of Table 2, the following are evident.

From the comparison between E1 vs. C2, E2/E3 vs. C4, E4 vs. C7, or E5/E6 vs. C9, the dispersions containing 1, 3 or 5 weight % of barium nitrate has effectively increased the CCT from about 15% to about 100%, wherein the degree of improvement corresponding to the amount of the water soluble alkaline earth metal salt.

In one embodiment, the aqueous dispersion of the present invention comprises, consists essentially of, contains from about 1 to about 10 weight %; preferably, from about 1 to about 8 weight % of a water soluble alkaline earth metal, wherein the water soluble alkaline earth metal is barium nitrate and the weight % is based on the PTFE particles.

TABLE 3

| Material | C2 | C4 | E7 | E8 | E9 | E10 |
|---|---|---|---|---|---|---|
| (a1) PTFE, % | 56.3 | 60.0 | 55.4 | 58.1 | 56.8 | 56.4 |
| (b) Nonionic surfactant(s), %* | 6.0 | 6.0 | 6.0 | 6.0 | 6.0 | 6.0 |
| HLB value | 14.0 | 13.8 | 14.0 | 13.8 | 13.8 | 13.8 |
| (c2) Colloidal silica, %* | — | — | 5.0 | 1.0 | 3.0 | 5.0 |
| Critical Cracking Thickness, | 10-12 | 9-11 | 20-22 | 12-14 | 16-18 | 20-22 |
| μm | | | | | | |

*The % of components (b) and (c) are based on the PTFE particles weight.

TABLE 4

| Material | C7 | C9 | E11 | E12 | E13 | E14 |
|---|---|---|---|---|---|---|
| (a1) PTFE, % | 60.4 | 58.4 | 56.3 | 58.1 | 56.8 | 55.8 |
| (b) Nonionic surfactant(s), %* | 10.0 | 10.0 | 10.0 | 10.0 | 10.0 | 10.0 |
| HLB value | 14.0 | 13.8 | 14.0 | 13.8 | 13.8 | 13.8 |
| (c2) Colloidal silica, %* | — | — | 5.0 | 1.0 | 3.0 | 5.0 |
| Critical Cracking Thickness, | 14-15 | 12-14 | 22-25 | 16-18 | 25-27 | 29-31 |
| μm | | | | | | |

*The % of components (b) and (c) are based on the PTFE particles weight.

From the results of Tables 3 and 4, the following are evident.

From the comparison between E7 vs. C2, E8/E9/E10 vs. C4, E11 vs. C7, or E12/E13/E14 vs. C9, the dispersion containing 1, 3, or 5 weight % of colloidal silica effectively provides an increase in CCT from about 25% to ˜150% corresponding to the amount of the colloidal silica.

In one embodiment, the aqueous dispersion of the present invention comprises, consists essentially of, contains from about 1 to about 10 weight %; preferably, from about 1 to about 8 weight % of a colloidal silica, wherein the colloidal silica has a specific surface area of between 200 to 300 m²/g and the weight % is based on the PTFE particles.

TABLE 5

| Material | C10 | E15 | E16 | C11 | E17 | E18 |
|---|---|---|---|---|---|---|
| (a2) PTFE, % | 60 | 56.4 | 53.8 | 58.4 | 55.1 | 52.0 |
| (b) Nonionic surfactant(s), %* | 6.0 | 6.0 | 6.0 | 10.0 | 10.0 | 10.0 |
| HLB value | 13.8 | 13.8 | 13.8 | 13.8 | 13.8 | 13.8 |
| (c1) Barium nitrate, %* | — | 3.0 | — | — | 3.0 | — |
| (c2) Colloidal silica, %* | — | — | 5.0 | — | — | 5.0 |
| Critical Cracking Thickness, | 4-6 | 7-8 | 14-16 | 7-8 | 8-10 | 18-20 |
| μm | | | | | | |

*The % of components (b) and (c) are based on the PTFE particles weight.

From the results of Table 5, the following are evident.

From the comparison between E15/E16 vs. C10 or E17/E18 vs. C11, the dispersions containing 3 weight % of barium nitrate or 5 weight % of colloidal silica have effectively increased the CCT. At 3% of barium nitrate, the dispersion demonstrated significant increased in CCT of the dispersion at least about 50%; at 5 weight % of colloidal silica, the dispersion demonstrated significant increased in CCT the dispersion up to 200%.

In one embodiment, the aqueous dispersion of the present invention comprises, consists essentially of, contains from about 50 to about 65 weight % of PTFE particles, wherein the PTFE particles has an average diameter of about 200 to 300 nm, and the weight % is based on the weight of the aqueous dispersion.

While the invention has been illustrated and described in typical embodiments, it is not intended to be limited to the details shown, since various modifications and substitutions are possible without departing from the spirit of the present invention. As such, modifications and equivalents of the invention herein disclosed may occur to persons skilled in the art using no more than routine experimentation, and all such modifications and equivalents are believed to be within the spirit and scope of the invention as defined by the following claims.

1. An aqueous dispersion of fluoropolymers comprising:
(a) from 45 to 70 weight %, based on the total weight of the dispersion, of polytetrafluoroethylene particles, the polytetrafluoroethylene particles are non-melt-processible;
(b) from 1 to 15 weight % of a nonionic surfactant; and
(c) from 1 to 10 weight % of a water soluble alkaline earth metal salt, or from 0.1 to 10 weight % of a colloidal silica;
wherein the weight % of component (b) or (c) is based on the weight of the polytetrafluoroethylene particles.

2. The aqueous dispersion of claim 1, wherein the polytetrafluoroethylene particles (a) comprise core/shell PTFE, PTFE. modified PTFE, or a mixture thereof.

3. The aqueous dispersion of claim 1 comprising from 50 to 65 weight % of the polytetrafluoroethylene particles (a), based on the total weight of the aqueous dispersion.

4. The aqueous dispersion of claim 1, the polytetrafluoroethylene particles (a) have an average particle size ranging from 200 to 300 nm.

5. The aqueous dispersion of claim 1 comprising from 4 to 12 weight % of the nonionic surfactant (b), based on the weight of the polytetrafluoroethylene particles.

6. The aqueous dispersion of claim 1, wherein the nonionic surfactant (b) comprises at least one aliphatic alcohol ethoxylate, or a mixture thereof.

7. The aqueous dispersion of claim 6 wherein the nonionic surfactant (b) is a compound or a mixture of compounds of the formula:
R(OCH₂CH₂)ₙOH
wherein R is a branched alkyl, branched alkenyl, cycloalkyl, or cycloalkenyl hydrocarbon group having 8-18 carbon atoms and n is an average value of 4 to 18.

8. The aqueous dispersion of claim 7 wherein the nonionic surfactant (b) is an ethoxylate of 2,6,8-trimethyl-4-nonanol having an average of 4 to 18 ethylene oxide (EO) units or a mixture thereof.

9. The aqueous dispersion of claim 8 wherein the nonionic surfactant (b) is a mixture of 2,6,8-trimethyl-4-nonanol ethoxylates having a HLB value of from 13.1 to 14.4, and more preferably 13.6 to 14.2.

10. The aqueous dispersion of claim 1, wherein the water soluble alkaline earth metal salt (c) is a nitrate salt of calcium, strontium or barium, or a mixture thereof.

11. The aqueous dispersion of claim 1 comprising from 1 to 8 weight % of the water soluble alkaline earth metal salt (c), based on the weight of the polytetrafluoroethylene particles.

12. The aqueous dispersion of claim 1, wherein the colloidal silica (c) has a specific surface area from 125 to 420 m²/g.

13. The aqueous dispersion of claim 12, wherein the colloidal silica (c) is a sodium stabilized colloidal silica and has a pH of 8.4-9.9 at 25° C.

14. The aqueous dispersion of claim 1 comprising from 1 to 8 weight % of the colloidal silica (c), based on the weight of the polytetrafluoroethylene particles.

15. The aqueous dispersion of any of claim 1 is essentially free of glass bubbles.

16. A coating composition comprising the aqueous dispersion of claim 1.

17. A substrate coated with the aqueous dispersion of claim 1 or the coating composition of claim 16.

18. The substrate of claim 17 wherein the substrate is porous fabric.

19. A substrate coated with the aqueous dispersion of claim 1 or the coating composition of claim 16, wherein the nonionic surfactant has been thermally removed.
